(19) United States
(12) Patent Application Publication
(10) Pub. No.: US 2026/0132670 A1
(43) Pub. Date: May 14, 2026

(54) FENESTRATION UNITS WITH SELECTIVE EXTERIOR/INTERIOR INSTALLATION FEATURES AND ASSOCIATED SYSTEMS AND METHODS

(71) Applicant: Pella Corporation, Pella, IA (US)

(72) Inventor: Matt Van Dyne, Pella, IA (US)

(73) Assignee: Pella Corporation, Pella, IA (US)

(21) Appl. No.: 19/382,727

(22) Filed: Nov. 7, 2025

Related U.S. Application Data
(60) Provisional application No. 63/718,252, filed on Nov. 8, 2024.

(51) Int. Cl. E06B 1/60; E06B 1/36

(52) U.S. Cl. CPC E06B 1/6053; E06B 1/36

(57) ABSTRACT

A fenestration unit fenestration unit includes a frame having a receiver channel. The fenestration unit further includes an installation fin having a pedestal portion and a projecting portion extending from the pedestal portion. The pedestal portion has a cam insert receivable in each of a first undercut and a second undercut of the receiver channel, a clip insert receivable in each of the first undercut and the second undercut, the pedestal portion including a retention catch. The projecting portion has a body and a retention protrusion receivable in the retention catch for securing the projecting portion in an upright position. The installation fin is reversibly couplable to the frame with the projecting portion extending in an interior direction in a first configuration of a prone position and with the projecting portion extending in an exterior direction in a second configuration of the prone position.

### CROSS-REFERENCE TO RELATED APPLICATION

This application claims priority to U.S. Provisional Patent Application No. 63/718,252, filed Nov. 8, 2024, the disclosure of which is hereby incorporated by reference in its entirety for all purposes.

### BACKGROUND

Window designs typically have an exterior nailing flange and are installed from the exterior side of the building. Two installers work together, one on the interior and the other on the exterior. Some installation crews have determined it is easier to use “interior-to-exterior” installation methods. Such methods generally include unpackaging the window in the interior of the building where it is relatively clean and flat. Then they pass the window through the rough opening to an installer on the exterior side. In some instances, the installer on the exterior side is on a ladder which can substantially complicate installation. The installer on the interior side centers the window in the rough opening and inserts shims to level, plumb and square all while the exterior installer is holding the window. After the window is correctly set, the interior installer holds the window in place while the exterior installer drives fasteners (for example, nails and/or screws) through the exterior nailing flange to anchor it. If it is a venting window, the sash is then opened to check functional operation. The interior installer proceeds to inject expansion foam around the perimeter of the window in the gap between the frame and rough opening to create the interior air seal. At the same time, the exterior installer applies 3 to 4 inches wide flashing tape on the nailing flange, the jambs, and across the head of the window.

In view of the complexity of interior-to-exterior installation methods, window designs have been developed that facilitate “interior” installation methods, or installation largely from the interior side of the building and by a single installer. Such methods generally include unpackaging the window in the interior of the building, gauging the window in the rough opening from the interior of the building by using one or more mounting brackets coupled to the perimeter of the window, and then inserting shims to level, plumb and square the window from the interior of the building. After the window is correctly set, the installer drives fasteners through the mounting brackets from the interior of the building to anchor the window in the rough opening. The installer then injects expansion foam around the perimeter of the window in the gap between the frame and rough opening to create the interior air seal. The installer then moves to the exterior of the building and drives fasteners through the exterior nailing flange to further secure the window, and/or apply flashing tape on the nailing flange, the jambs, and across the head of the window.

Background Patents

| Patent Number | Title | Filing Date |
|---|---|---|
| U.S. Pat. No. | Fenestration frame with bonded | 2011 Apr. 20 |
| 8,621,795 | support brackets . . . | |
| U.S. Pat. No. | Spring clip and method of window | 2004 Feb. 13 |
| 7,162,841 | installation | |
| DE 2020 | Supporting and fastening | 2016 Mar. 11 |
| 16101375 | window . . . to . . . wall opening | |
| WO 2015/142201 | Mounting, sealing and thermal | 2014 Sep. 5 |
| | insulation of windows . . . | |
| U.S. Pat. No. | System and method for installing | 1999 Sep. 30 |
| 6,293,061 | a jamb | |
| U.S. Pat. No. | Installation features for | 2019 Jul. 25 |
| 11,332,946 | fenestration units . . . | |
| U.S. Pat. No. | Self-sealing window installation | 2008 Jan. 15 |
| 8,006,445 | and method | |
| U.S. 2008/0127564 | Pre-hung door assembly and | 2008 Jan. 18 |
| | method of installation | |
| U.S. Pat. No. | Support bracket for window | 2016 Aug. 23 |
| 10,895,099 | installation . . . | |
| U.S. Pat. No. | Door Hanger Bracket | 2018 Sep. 21 |
| 10,794,069 | | |
| U.S. RE45,355 | Door Hanger | 2012 Nov. 19 |
| U.S. Pat. No. | Fenestration Units with Interior | 2023 Sep. 29 |
| 11,933,098 | Installation Features and | |
| | Associated Systems and Methods | |

### Background Products

Innotech Windows & Doors, Strap Anchors https://www.innotech-windows.com/blog/in-depth-benefits-of-anchoring-method-window-installation
FrontLine Tru-Loc™ Brackets https://frontlinebldg.com/all-products/accessories/tru-loc-window-door-installation-anchor/
Amesbury Hinged Fin https://www.amesburytruth.com/products/extrusions/nailing-fin/hinged/hinged-pp1219

### SUMMARY

Various advantages may be achieved according to the example systems and methods described herein. Such advantages may include installation versatility, more specifically selective configuration, or reconfiguration, of fenestration units to facilitate exterior installation methods, interior-to-exterior installation methods, or interior installation methods. Using these different installation methods may depend on, for example, installer preferences and/or environmental considerations, such as fenestration units being installed above a first floor of a building and requiring use of a ladder.

According to one example (“Example 1”), a fenestration unit has an interior side and an exterior side and being configured to be installed in a rough opening in a structure. The fenestration unit further includes a frame including a top, a bottom, a first side, and a second side together defining a perimeter of the frame, the frame having a receiver channel extending along the perimeter, the receiver channel being defined by a first lip, a second lip opposing the first lip, and a base over which the first and second lips extend, the first and second lips defining a gap between the first and second lips, and a first undercut between the first lip and the base and a second undercut between the second lip and the base; and an installation fin including a pedestal portion, a projecting portion extending from the pedestal portion, and a flexible hinge between the pedestal portion and a projecting portion such that the installation fin is transitionable from a prone position in which the projecting portion lays substantially flat relative to the perimeter of the frame to an upright position in which the projecting portion extends outward from the perimeter of the frame, the pedestal portion having a cam insert receivable in each of the first undercut and the second undercut, a clip insert receivable in each of the first undercut and the second undercut, the pedestal portion including a retention catch, the projecting portion having a body and a retention protrusion receivable in the retention catch for securing the projecting portion in the upright position, the installation fin being reversibly couplable to the frame with the projecting portion extending toward the interior side in an interior direction in a first configuration of the prone position and with the projecting portion extending toward the exterior side in an exterior direction in a second configuration of the prone position.

According to another example (“Example 2”), the fenestration unit of Example 1, wherein the pedestal portion is configured to remain at least partially disposed in the receiver channel when the installation fin is moved relative to the frame from the prone position to the upright position.

According to another example (“Example 3”), the fenestration unit of Example 1, wherein the projecting portion having a first elastic modulus, the cam insert having a second elastic modulus, the second elastic modulus being less than the first elastic modulus.

According to another example (“Example 4”), the fenestration unit of Example 3, wherein the projecting portion is constructed of a first material having the first elastic modulus, the cam insert is constructed of a second material having the second elastic modulus, and the first material is different than the second material.

According to another example (“Example 5”), the fenestration unit of Example 1, wherein the pedestal portion further includes a stopper configured to be disposed outside of the receiver channel, each of the first lip and the second lip being receivable between the stopper and the clip insert.

According to another example (“Example 6”), the fenestration unit of Example 5, wherein the cam insert and the stopper each seal to the frame.

According to another example (“Example 7”), the fenestration unit of Example 5, wherein the projecting portion is constructed of a first material having the first elastic modulus, the stopper is constructed of a second material having the second elastic modulus, and the first material is different than the second material.

According to another example (“Example 8”), the fenestration unit of Example 1, wherein in the prone position the installation fin protrudes from the frame by a maximum distance in a range of about 0.100 inches to about 0.050 inches.

According to another example (“Example 9”), a fenestration unit has an interior side and an exterior side and is configured to be installed in a rough opening in a structure. The fenestration unit includes a frame including a top, a bottom, a first side, and a second side together defining a perimeter of the frame, the frame having a receiver channel extending along the perimeter, the receiver channel being defined by a first lip, a second lip opposing the first lip, and a base over which the first lip and the second lip extend, the first lip and the second lip defining a gap between the first lip and the second lip, and a first undercut between the first lip and the base and a second undercut between the second lip and the base; and an installation fin including a pedestal portion configured to be coupled to the frame, a projecting portion, and a hinge portion coupling the projecting portion to the coupling portion, the pedestal portion having a cam insert receivable in both of the first undercut and the second undercut, a clip insert receivable in both of the first undercut and the second undercut, and a retention catch, and the projecting portion having a body and a retention protrusion; wherein the installation fin is reversibly couplable to the frame in a first configuration and a second configuration, in the first configuration the cam insert being received in the first undercut, the clip insert being received in the second undercut, the projecting portion being movable, via the hinge portion, relative to the frame from a first prone position to a first upright position, in the first prone position the projecting portion extending toward the interior side, and in the first upright position the projecting portion extending outwardly from the perimeter and the retention protrusion being received in the retention catch to secure the projecting portion, in the second configuration the cam insert being received in the second undercut, the clip insert being received in the first undercut, the projecting portion being movable, via the hinge portion, relative to the frame from a second prone position to a second upright position, and in the second prone position the projecting portion extending toward the exterior side, and in the second upright position the projecting portion extending outwardly from the perimeter and the retention protrusion being received in the retention catch to secure the projecting portion.

According to another example (“Example 10”), the fenestration unit of Example 9, wherein the projecting portion has a first elastic modulus, the cam insert has a second elastic modulus, the second elastic modulus being less than the first elastic modulus.

According to another example (“Example 11”), the fenestration unit of Example 10, wherein the projecting portion is constructed of a first material having the first elastic modulus, the cam insert is constructed of a second material having the second elastic modulus, and the first material is different than the second material.

According to another example (“Example 12”), the fenestration unit of Example 9, wherein the pedestal portion further includes a stopper configured to be disposed outside of the receiver channel, in the first configuration the second lip being received between the clip insert and the stopper, and in the second configuration the first lip being received between the clip insert and the stopper.

According to another example (“Example 13”), the fenestration unit of Example 12, wherein the cam insert and the stopper each seal to the frame.

According to another example (“Example 14”), the fenestration unit of Example 9, wherein the hinge portion flexes when the installation fin is moved relative to the pedestal portion from the first prone position to the first upright position and from the second prone position to the second upright position.

According to another example (“Example 15”), the fenestration unit of Example 9, wherein the projecting portion is disposed in a transverse plane in both the first upright position and the second upright position.

According to another example (“Example 16”), the fenestration unit of Example 9, wherein in the first prone position and the second prone position the installation fin protrudes from the frame by a maximum distance in a range of about 0.100 inches to about 0.050 inches.

According to another example (“Example 17”), a method of installing a fenestration unit in a rough opening in a structure defined by rough opening framing is provided. The fenestration unit includes an interior side, an exterior side, a frame having a top, a bottom, a first side, and a second side together defining a perimeter of the frame, the frame having a receiver channel extending along the perimeter, the receiver channel being defined by a first lip, a second lip opposing the first lip, and a base over which the first and second lips extend, the first and second lips defining a gap between the first and second lips, and a first undercut between the first lip and the base and a second undercut between the second lip and the base, and an installation fin including a pedestal portion, a projecting portion, and a flexible hinge between the pedestal portion and the projecting portion, the pedestal portion having a cam insert, a clip insert, and a retention catch, and the projecting portion having a body and a retention protrusion. The method includes: receiving the fenestration unit with the installation fin coupled to the frame in one of a first configuration and a second configuration, in the first configuration the cam insert being received in the first undercut, the clip insert being received in the second undercut, the projecting portion being movable, via the flexible hinge, relative to the frame from a first prone position to a first upright position, in the first prone position the projecting portion extending toward the interior side, and in the first upright position the projecting portion extending outwardly from the perimeter and the retention protrusion being received in the retention catch to secure the projecting portion, in the second configuration the cam insert being received in the second undercut, the clip insert being received in the first undercut, the projecting portion being movable, via the flexible hinge, relative to the frame from a second prone position to a second upright position, and in the second prone position the projecting portion extending toward the exterior side, and in the second upright position the projecting portion extending outwardly from the perimeter and the retention protrusion being received in the retention catch to secure the projecting portion; detaching the installation fin from the frame; coupling the installation fin to the frame in the other of the first configuration and the second configuration and positioning the installation fin in the first upright position or the second upright position, respectively; seating the fenestration unit in the rough opening by together translating the frame and the installation fin toward the rough opening; and securing the fenestration unit to the rough opening framing.

According to another example (“Example 18”), the method of Example 17, wherein coupling the installation fin to the frame includes coupling the installation fin to the frame in the first configuration and positioning the installation fin in the first upright position.

According to another example (“Example 19”), the method of Example 17, wherein coupling the installation fin to the frame includes coupling the installation fin to the frame in the second configuration and positioning the installation fin in the second upright position.

According to another example (“Example 20”), the method of Example 17, wherein detaching the installation fin from the frame includes removing the pedestal portion from the channel, and coupling the installation fin to the frame includes positioning the pedestal portion in the channel.

According to another example (“Example 21”), the method of Example 20, wherein the projecting portion has a first elastic modulus, the cam insert has a second elastic modulus, the second elastic modulus being less than the first elastic modulus.

According to another example (“Example 22”), the method of Example 20, wherein positioning the installation fin in the first upright position or the second upright position includes pivoting the projecting portion, via the flexible hinge, relative to the pedestal portion.

According to another example (“Example 23”), the method of Example 17, wherein securing the fenestration unit to the rough opening framing includes passing a plurality of fasteners through the installation fin and into the rough opening framing.

According to another example (“Example 24”), the method of Example 17, wherein in the first prone position and the second prone position the installation fin protrudes from the frame by a maximum distance in a range of about 0.100 inches to about 0.050 inches.

According to another example (“Example 25”), the method of Example 17, wherein detaching the installation fin from the frame includes moving the installation fin in a direction substantially perpendicular to a longitudinal axis of the receiver channel.

According to another example (“Example 26”), the method of Example 17, wherein coupling the installation fin to the frame in the other of the first configuration and the second configuration includes moving the installation fin in a direction substantially perpendicular to a longitudinal axis of the receiver channel.

The foregoing embodiments and additional embodiments described herein should not be read to limit or otherwise narrow the scope of any of the inventive concepts otherwise provided by the instant disclosure. While multiple examples are disclosed, still other embodiments will become apparent to those skilled in the art from this specification and its drawings, which show and describe various illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a top-oriented perspective view of a fenestration unit from an interior side and with an installation system thereof in a prone position, according to some embodiments.

FIG. 2 is a top-oriented perspective view of the fenestration unit of FIG. 1 from an exterior side and with the installation system in the prone position, according to some embodiments.

FIG. 3 is a top-oriented perspective view of the fenestration unit of FIG. 1 from the interior side and with the installation system in an upright position, according to some embodiments.

FIG. 4 is a bottom sectional view of the fenestration along line 4-4 of FIG. 1 and with the installation system in a first prone position of a first configuration relative to a frame of the fenestration unit, according to some embodiments.

FIG. 5 is a bottom sectional view of the fenestration along line 5-5 of FIG. 3 and with the installation system in a first upright position of the first configuration relative to the frame of the fenestration unit, according to some embodiments.

FIG. 6 is a bottom sectional view of the fenestration unit similar to FIG. 4, except illustrating the installation system in a second prone position of a second configuration relative to the frame of the fenestration unit, according to some embodiments.

FIG. 7 is a bottom sectional view of the fenestration unit similar to FIG. 5, except illustrating the installation system in a second upright position of a second configuration relative to the frame of the fenestration unit, according to some embodiments.

FIG. 8 is a side view of an installation fin of the installation system of the fenestration unit of FIG. 1 in the first upright position relative to the frame of the fenestration unit, according to some embodiments.

FIG. 9 is a side view of the installation fin of FIG. 8 in the second upright position relative to the frame of the fenestration unit, according to some embodiments.

FIG. 10 is a front view of the installation fin of FIG. 8 in the first upright position, according to some embodiments.

FIG. 11 is a side view of the installation fin of FIG. 8 being pivoted between the first prone position and the first upright position, according to some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale and may be exaggerated to illustrate various aspects of the present disclosure, and in that regard, the drawing figures should not be construed as limiting.

### DESCRIPTION OF VARIOUS EMBODIMENTS

Various concepts of this patent specification address installation systems and methods for fenestration units, such as windows and doors. In various examples, fenestration units include features that facilitate installation using any of (1) exterior installation methods by two or more installers, (2) interior-to-exterior installation methods by two or more installers, and (3) interior installation methods by a single installer. In certain embodiments, fenestration units include storable and deployable installation systems/exterior water barriers (for example, constrained by removable packaging clips for shipping/installation).

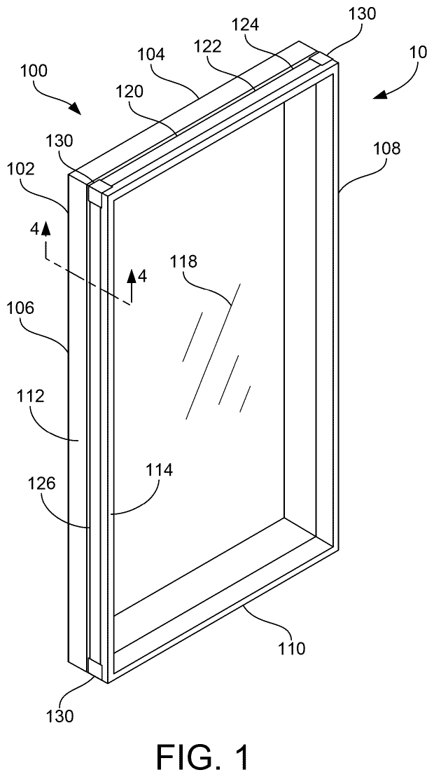

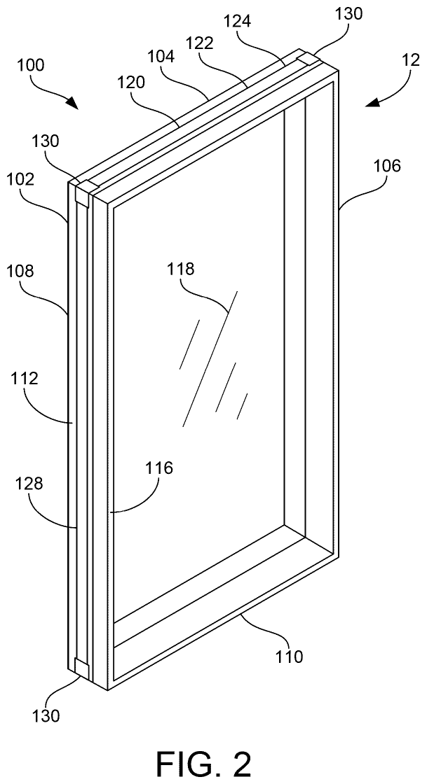

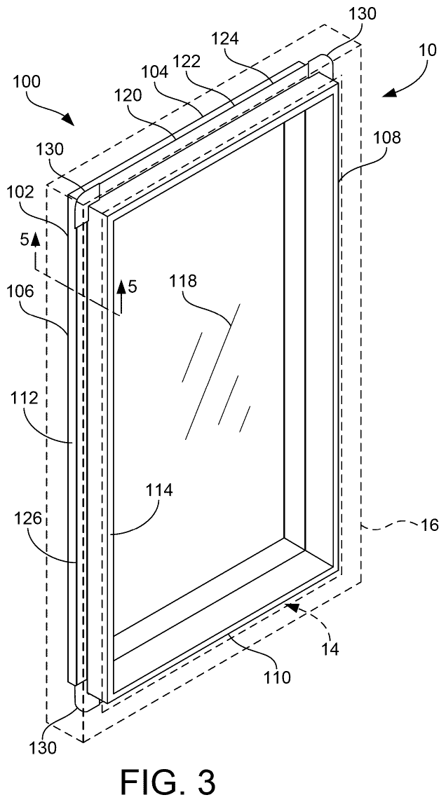

FIGS. 1-3 illustrate a fenestration unit 100, according to some embodiments, where FIGS. 1 and 3 are top-oriented perspective views from an interior side 10 of a building or wall and FIG. 2 is a top-oriented perspective view from an exterior side 12 of the building or wall. As described in further detail below, the fenestration unit 100 is configured to be installed in a rough opening 14 defined by rough opening framing 16 (illustrated in phantom lines in FIG. 3) of the building or wall.

As shown in FIGS. 1-3, the fenestration unit 100 includes a frame 102 including a top or head 104, a first side or jamb 106, a second side or jamb 108, and a bottom or sill 110. These components of the frame 102 together define an outer perimeter 112, a front or interior face 114 (FIGS. 1 and 3), as well as a back or exterior face 116 (FIG. 2). The frame 102 may be constructed of vinyl, fiberglass, wood, or other materials. The fenestration unit 100 also includes a panel unit or glazing unit 118 supported by the frame 102. The glazing unit 118 may be any of a variety of configurations, and in some embodiments is an insulated glass (IG) unit. As shown, the fenestration unit 100 is configured as a fixed window, but a variety of window configurations (casement, single hung, double hung, awning or other) and door configurations (doors with one or more movable panels and one or more fixed panels) are also contemplated.

With further reference to FIGS. 1-3, the fenestration unit 100 also includes an installation system 120 that facilitates coupling the fenestration unit 100 to the rough opening framing 16. FIGS. 1 and 2 illustrate the installation system 120 in a prone position in which the system 120 is disposed against or near the perimeter of the frame 102, which may be associated with an initial, or pre-installation state of the fenestration unit 100 (for example, as initially received by an installer). That is, the prone position may provide the fenestration unit 100 with a relatively compact configuration. In the prone position, the installation system 120, more specifically an installation fin thereof 124, may protrude from the frame 102 by a relatively small maximum distance, for example a distance in a range of about 0.100 inches to about 0.050 inches, more specifically a distance in a range of about 0.080 inches to about 0.060 inches, and even more specifically a distance of about 0.072 inches. Such relatively small distances can have a variety of benefits, such as facilitating use of typical block frame packaging that is commonly used for shipping fenestration units. FIG. 3 illustrates the installation system 120 in an upright position in which the system 120 generally extends outwardly from the perimeter 112 of the frame 102, which may be associated with a final, installed state, or installation state of the fenestration unit 100 (for example, secured in the rough opening 14). In the upright position, the installation system 120 may be configured to receive a plurality of fasteners (not shown) to facilitate securing the fenestration unit 100 to the rough opening framing 16 and/or receive flashing tape (not shown) to facilitate sealing the rough opening 14.

FIGS. 1-3 illustrate the installation system 120 in a first configuration, or a first orientation, relative to the frame 102. More specifically, FIGS. 1 and 2 illustrate the installation system 120 in a first prone position, in which the system 120 generally extends toward the interior side 10, and FIG. 3 illustrates the installation system 120 in a first upright position. As described in further detail below, the installation system 120 is reversibly couplable to the frame 102. More specifically, the installation system 120 is selectively couplable to the frame 102 in a second, reversed configuration in which the installation system 120 is positionable in a second prone position and a second upright position. As also described in further detail below, the first configuration of the installation system 120 may facilitate installing the unit 100 using exterior installation methods or interior-to-exterior installation methods, and the second configuration of the installation system 120 may facilitate installing the unit 100 using interior installation methods.

The installation system 120 illustratively includes an installation fin assembly 122 having a head installation fin 124, a first jamb installation fin 126 (FIGS. 1 and 3), a second jamb installation fin 128 (FIG. 2), and a sill installation fin (not shown) positioned on the head 104, the first jamb 106, the second jamb 108, and the sill 110 of the frame 102, respectively. In other examples, the installation system 120 includes a different number of portions. The installation system 120 further illustratively includes corner bridge seals 130 coupling adjacent portions of the installation system 120. The corner bridge seals 130 may be, for example, any of the corner bridge seals described in U.S. Pat. No. 11,933,098, issued Mar. 19, 2024, the disclosure of which is incorporated by reference in its entirety.

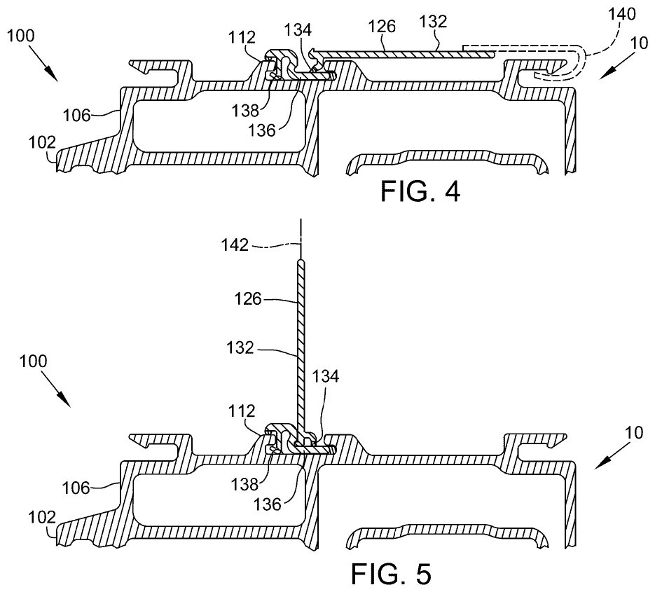

FIGS. 4 and 5 are sectional views illustrating the first jamb installation fin 126 in the first configuration, or the first orientation, relative to the first jamb 106 of the frame 102. The head installation fin 124 and the head 104, the second jamb installation fin 128 and the second jamb 108, and the sill installation fin and the sill 110 may have, for example, different lengths, but otherwise substantially similar constructions as the installation fin 126.

FIG. 4 more specifically illustrates the installation fin 126 in the first prone position of the first configuration, and FIG. 5 more specifically illustrates the installation fin 126 in the first upright position of the first configuration. In the first prone position, as shown in FIG. 4, a projecting portion 132 of the installation fin 126 lays substantially flat relative to the perimeter 112 of the frame 102 and extends toward the interior side 10 of the unit 100. To transition the installation fin 126 to the first upright position, as shown in FIG. 5, the projecting portion 132 pivots, via a hinge portion or flexible hinge 134 of the fin 126, relative to a pedestal portion 136 of the installation fin 126 coupled to the frame 102. In some examples, the projecting portion 132 pivots approximately 90 degrees from the first prone position to the first upright position. In certain examples, the pedestal portion 136 of the installation fin 126 remains coupled to the frame 102, more specifically the pedestal portion 136 remains partially disposed in a receiver channel 138 of the frame 102, when the projecting portion 132 is moved relative to the frame 102 from the first prone position to the first upright position. In the first upright position, as illustrated, the projecting portion 132 extends outward from the perimeter 112 of the frame 102.

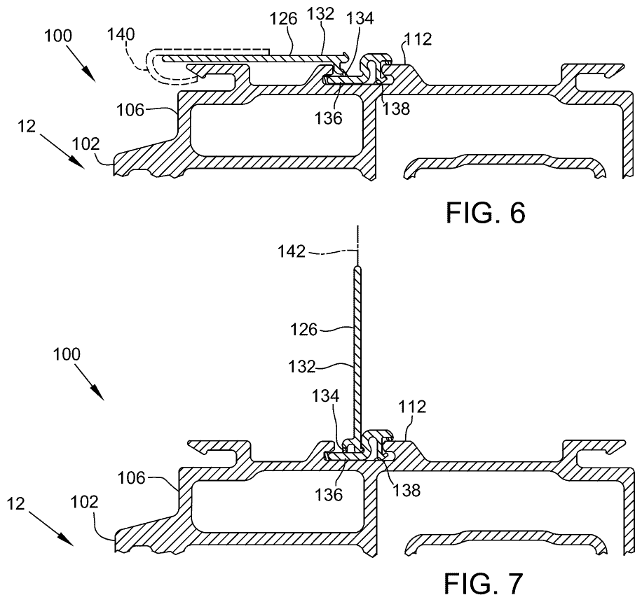

The installation fin 126 is selectively detachable from the frame 102, more specifically, the pedestal portion 136 is selectively removable from the receiver channel 138. As described briefly above, the installation fin 126 is selectively couplable to the frame 102 in a second, reversed configuration, more specifically, the pedestal portion 136 is selectively positionable in the receiver channel 138 in a reversed configuration. FIGS. 6 and 7 are sectional views illustrating the first jamb installation fin 126 in the second configuration relative to the first jamb 106 of the frame 102. FIG. 6 more specifically illustrates the installation fin 126 in the second prone position of the second configuration, and FIG. 7 more specifically illustrates the installation fin 126 in the second upright position of the second configuration. In the second prone position, as shown in FIG. 6, the projecting portion 132 of the installation fin 126 lays substantially flat relative to the perimeter 112 of the frame 102 and extends toward the exterior side 12 of the unit 100. To transition the installation fin 126 to the second upright position, as shown in FIG. 7, the projecting portion 132 pivots, via the flexible hinge 134 of the fin 126, relative to the pedestal portion 136 of the installation fin 126. In some examples, the projecting portion 132 pivots approximately 90 degrees from the second prone position to the second upright position. In certain examples, the pedestal portion 136 of the installation fin 126 remains coupled to the frame 102, more specifically the pedestal portion 136 remains partially disposed in the receiver channel 138 of the frame 102, when the projecting portion 132 is moved relative to the frame 102 from the second prone position to the second upright position. In the second upright position, as illustrated, the projecting portion 132 extends outward from the perimeter 112 of the frame 102.

In certain embodiments, the features of the pedestal portion 136, as described in further detail below, advantageously facilitate “snap fitting” the installation fin 126 in the receiver channel 138 of the frame 102. That is, the pedestal portion 136 is insertable into and removable from the receiver channel 138 by moving the installation fin 126 in a direction substantially perpendicular to the longitudinal axis of the channel 138. For reference, “substantially perpendicular” includes camming and clipping types of movements. In contrast, other installation fins are typically inserted in receiver channels by sliding the fins longitudinally from the ends of the channels, which can be difficult or impractical for a variety of reasons, such as increased friction due to variation in component dimensions, access, and others.

In some examples, the installation fin 126 may be held in an initial position (for example, the first prone position or the second prone position) by a retaining assembly 140, which may be, for example, any of the retaining assemblies described in U.S. Pat. No. 11,933,098 previously incorporated by reference. Relatedly, in certain examples, the installation fin 126 may be biased toward a deployed position (for example, the first upright position or the second upright position) and may automatically move to the deployed position upon detachment of the retaining assembly 140.

Referring briefly to FIGS. 4 and 6, in some examples, the projecting portion 132 of the installation fin 126 is disposed in a transverse plane 142 in both the first upright position (FIG. 4) and the second upright position (FIG. 6). Illustratively, the transverse plane 142 substantially bisects the receiver channel 138 of the frame 102. Advantageously, such a construction facilitates similarly gauging the fenestration unit 100 relative to the rough opening framing 16 (shown elsewhere) in the first configuration and the second configuration of the installation fin 126, more specifically the first upright position or the second upright position.

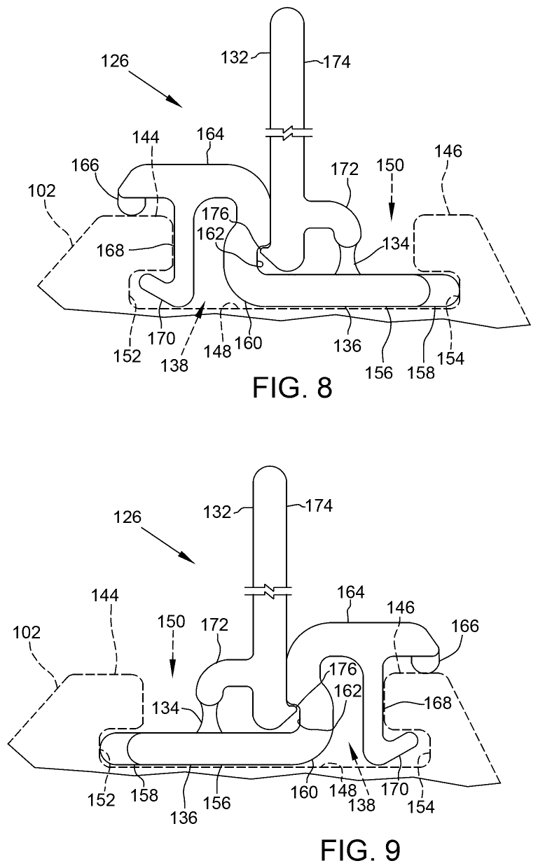

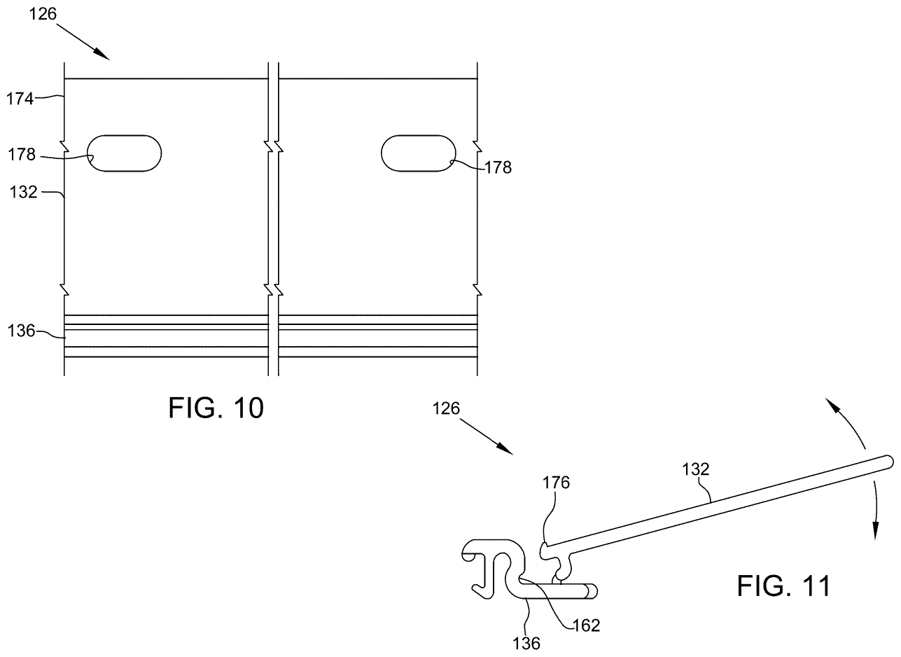

FIGS. 8-11 illustrate further details of the installation fin 126, and FIGS. 8 and 9 additionally illustrate further details of the receiver channel 138 of the frame 102 (shown in phantom lines). FIGS. 8 and 10 illustrates the installation fin 126 in the first upright position of the first configuration relative to the frame 102, FIG. 9 illustrates the installation fin 126 in the second upright position of the second configuration relative to the frame 102, and FIG. 11 illustrates the installation fin 126 being pivoted between the first prone position and the first upright position of the first configuration.

Referring specifically to FIGS. 8 and 9, the receiver channel 138 of the frame 102 is illustratively defined by a first lip 144, an opposite second lip 146, and a base 148 over which the first lip 144 and the second lip 146 extend. The first lip 144 and the second lip 146 define a gap 150 therebetween, the first lip 144 and the base 148 define a first undercut 152 therebetween, and the second lip 146 and the base 148 define a second undercut 154 therebetween.

With continued reference to FIGS. 8 and 9 and as described briefly above, the pedestal portion 136 of the installation fin 126 is disposed in the receiver channel 138 of the frame 102 in both the first configuration (FIG. 8) and the second configuration (FIG. 9). The pedestal portion 136 illustratively includes a lower section 156 that is positionable against the base 148 of the receiver channel 138. The lower section 156 includes a cam insert 158 that is receivable in both of the first undercut 152 and the second undercut 154 of the receiver channel 138. More specifically, in the first configuration (FIG. 8) the cam insert 158 is received in the second undercut 154, and in the second configuration (FIG. 9) the cam insert 158 is received in the first undercut 152. Illustratively, the cam insert 158 has a relatively flat shape similar to the shape of the first and second undercuts 152, 154. The lower section 156 of the pedestal portion 136 couples to the flexible hinge 134, which is also coupled to the projecting portion 132. Features of the projecting portion 132 are described in further detail below. The lower section 156 of the pedestal portion 136 couples to an intermediate section 160 opposite the cam insert 158. The intermediate section 160 includes a retention catch or indentation 162 that selectively receives the projecting portion 132, as described in further detail below.

With further reference to FIGS. 8 and 9, the intermediate section 160 of the pedestal portion 136 couples to an upper section 164 opposite the lower section 156. The upper section 164 includes a stopper 166 that is positionable outside of the receiver channel 138. More specifically, in the first configuration (FIG. 8) the stopper 166 is positioned atop the first lip 144, and in the second configuration (FIG. 9) the stopper 166 is positioned atop the second lip 146. A clip insert 168 extends away from the upper section 164 and into the receiver channel 138, and the clip insert 168 is receivable in both of the first undercut 152 and the second undercut 154. More specifically, in the first configuration (FIG. 8) a toe 170 of the clip insert 168 is received in the first undercut 152, and in the second configuration (FIG. 9) the toe 170 of the clip insert 168 is received in the second undercut 154. As a result, both of the first lip 144 and the second lip 146 are receivable between the clip insert 168 and the stopper 166. More specifically, in the first configuration (FIG. 8) the first lip 144 is received between the toe 170 of the clip insert 168 and the stopper 166, and in the second configuration (FIG. 9) the second lip 146 is received between the toe 170 of the clip insert 168 and the stopper 166.

As described above, the cam insert 158, the stopper 166, and the clip insert 168 facilitate securing the pedestal portion 136 of the installation fin 126 in the receiver channel 138 of the frame 102. However, the installation fin 126 is relatively flexible to facilitate detachment from the frame 102, for example, by deflecting one or more of the lower section 156, the intermediate section 160, and the upper section 164 and removing the pedestal portion 136 from the receiver channel 138. In certain examples, one or more sections of the pedestal portion 136 have increased flexibility to facilitate detachment from and reattachment to the frame 102. More specifically, one or more sections of the pedestal portion 136 may be constructed of a first material having a first elastic modulus, one or more other sections of the pedestal portion 136 may be constructed of a second material having a second elastic modulus, and the second elastic modulus is less than the first elastic modulus and/or the second material is different than the first material. For example, the cam insert 158 and the stopper 166 may be constructed of the second material and the remainder of the pedestal portion 136 may be constructed of the first material. Relatedly, the flexible hinge 134 may have increased flexibility compared to other portions of the installation fin 126. For example, the flexible hinge 134 may be constructed of the second material and the projecting portion 132 may be constructed of the first material. In some examples, the first material is a relatively stiff polymer, such as polyvinyl chloride (PVC), and the second material is a relatively flexible polymer, such as rubber.

In certain embodiments, the installation fin 126 advantageously seals to the frame 102 at multiple locations, thereby inhibiting or preventing air and water permeability of the fenestration unit 100. More specifically, the cam insert 158 and/or the stopper 166 each seal to the frame 102, providing enhanced water performance. Additional sealing members (e.g., weather stripping, weather seal tapes, and other features) may also be applied to the cam insert 158 and/or stopper 166 (e.g., pre-applied) to enhance water performance.

With continued reference to FIGS. 8 and 9, the projecting portion 132 includes a leg section 172 coupled to the flexible hinge 134 and a main body 174 coupled to the leg section 172 opposite the flexible hinge 134. The main body 174 illustratively includes a retention protrusion 176 that is receivable in the retention catch 162 of the pedestal portion 136 for securing the projecting portion 132 in the first upright position (FIG. 8) and the second upright position (FIG. 9). In other examples, the pedestal portion 136 and the projecting portion 132 have the opposite retention features. More specifically, the pedestal portion 136 could include a retention protrusion and the projecting portion 132 could include a retention catch.

Referring to FIG. 10, the main body 174 of the projecting portion 132 of the installation fin 126 illustratively includes one or more apertures 178. Such apertures 178 facilitate partially passing fasteners (not shown) therethrough and thereby securing the installation fin 126 and the fenestration unit 100 to the rough opening framing 16 (shown elsewhere); that is, the installation fin 126 acts as a nailing flange. The apertures 178 may be provided with various shapes and/or arrangements.

FIG. 11 illustrates the installation fin 126 being pivoted between the first prone position and the first upright position of the first configuration. As illustrated, the retention protrusion 176 of the projecting portion 132 is disposed apart from the retention catch 162 of the pedestal portion 136 when the installation fin 126 is pivoted between the first prone position and the first upright position and, similarly, when the installation fin 126 is positioned in the first prone position. Although not specifically illustrated, the retention protrusion 176 is similarly disposed apart from the retention catch 162 when the installation fin 126 is pivoted between the second prone position and the second upright position of the second configuration and when the installation fin 126 is positioned in the second prone position.

In some examples, the fenestration unit 100 includes one or more additional systems that facilitate properly positioning in the rough opening 14 and/or securing to the rough opening framing 16. More specifically, the fenestration unit 100 may include a mounting bracket system, a retention system including an installation stabilizer system, and/or a sill spacer system, such as any of those described in U.S. Pat. No. 11,933,098 previously incorporated by reference.

With further reference to the figures in general, in some examples the fenestration unit 100 may be initially configured in either the first configuration or the second configuration by a manufacturer. More specifically, the fenestration unit 100 may be initially configured in the first configuration to facilitate exterior installation methods or interior-to-exterior installation methods, or the fenestration unit 100 may be initially configured in the second configuration to facilitate interior installation methods. In certain examples, the fenestration unit 100 may be reconfigured from the first configuration to the second configuration, or the second configuration to the first configuration, by the manufacturer or an installer. As an example, a method for reconfiguring the fenestration unit 100 from the first configuration (or the second configuration) to the second configuration (to the first configuration) is follows. Upon receiving the fenestration unit 100 in the first configuration (or the second configuration), the installation system 120 is detached from the frame 102 More specifically, the pedestal portion 136 of the installation fin 126 is removed from the receiver channel 138. The installation system 120 is then coupled to the frame 102 in the second configuration (or the first configuration). More specifically, the pedestal portion 136 is positioned in the channel 138 in the opposite configuration. Even more specifically, the cam insert 158 may first be positioned in the second undercut 154 (or the first undercut 152) and the toe 170 of the clip insert 168 may then be slid along the first lip 144 of the channel 138 (or the second lip 146 of the channel 138) and snapped into the first undercut 152 (or the second undercut 154). The fenestration unit 100 then may be installed in the rough opening 14, for example, using one of the methods described below.

As examples, an exterior installation method and an interior-to-exterior installation method for positioning the fenestration unit 100 in the rough opening 14 are generally as follows. In certain examples, the fenestration unit 100 is initially received in, or reconfigured to, the first prone position of the first configuration (that is, as shown in FIGS. 1 and 2). The fenestration unit 100 is then transitioned to an installing state. More specifically, the installation system 120 is transitioned from the first prone position to the first upright position (that is, as shown in FIG. 3) by pivoting the projecting portion 132 relative to the pedestal portion 136 via the flexible hinge 134. For an exterior installation method, such actions may be conducted on the exterior side of the rough opening 14 and, conversely, for an interior-to-exterior installation method, such actions may be conducted on the interior side of the rough opening 14. The fenestration unit 100 is then positioned in the rough opening 14. For an exterior installation method, the fenestration unit 100 is inserted or pushed by an exterior installer into the rough opening 14 from the exterior side of the rough opening 14. For an interior-to-exterior installation method, the fenestration unit 100 is first passed from an interior installer through the rough opening 14 and to an exterior installer, and the exterior installer then inserts or pushes the fenestration unit 100 into the rough opening 14 from the exterior side of the rough opening 14. The interior installer then centers, levels, plumbs, and squares the unit 100 in the rough opening 14 while the exterior installer holds the unit 100. After the unit 100 is correctly set, the interior installer holds the unit 100 in position while the exterior installer drives fasteners (for example, nails and/or screws) through the installation fins 124, 126, and 128 to secure the unit 100 to the rough opening framing 16. The interior installer then injects expansion foam around the unit 100 in the gap between the frame 102 and the rough opening framing 16 to create the interior air seal, and the exterior installer applies flashing tape on the installation system 120, the jambs 106, 108, and across the head 104 of the unit 100.

As another example, an interior installation method is generally as follows. In certain examples, the fenestration unit 100 is initially received in, or reconfigured to, the second prone position of the second configuration (that is, as shown in FIG. 6). The fenestration unit 100 is then positioned in the rough opening 14. More specifically, the fenestration unit 100 is inserted or pushed by an installer into the rough opening 14 from the interior side of the rough opening 14. In certain examples, one or more mounting brackets (not shown) coupled to the frame 102 of the unit 100 facilitate gauging the unit 100 in the rough opening 14 and inhibit the unit 100 from falling out of the exterior side of the rough opening 14. The installer then centers, levels, plumbs, and squares the unit 100 in the rough opening 14. After the unit 100 is correctly set, the installer drives fasteners (for example, nails and/or screws) through the mounting brackets to secure the unit 100 to the rough opening framing 16. The installer then injects expansion foam around the unit 100 in the gap between the frame 102 and the rough opening framing 16 to create the interior air seal. The fenestration unit 100 is then transitioned to an installed state. More specifically, the installer moves to the exterior side of the rough opening 14 and transitions the installation system 120 from the second prone position to the second upright position (that is, as shown in FIG. 7) by pivoting the projecting portion 132 relative to the pedestal portion 136 via the flexible hinge 134. The installer then applies flashing tape on the installation system 120, the jambs 106, 108, and across the head 104 of the unit 100.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A fenestration unit having an interior side and an exterior side and being configured to be installed in a rough opening in a structure, the fenestration unit comprising:
a frame including a top, a bottom, a first side, and a second side together defining a perimeter of the frame, the frame having a receiver channel extending along the perimeter, the receiver channel being defined by a first lip, a second lip opposing the first lip, and a base over which the first and second lips extend, the first and second lips defining a gap between the first and second lips, and a first undercut between the first lip and the base and a second undercut between the second lip and the base; and
an installation fin including a pedestal portion, a projecting portion extending from the pedestal portion, and a flexible hinge between the pedestal portion and a projecting portion such that the installation fin is transitionable from a prone position in which the projecting portion lays substantially flat relative to the perimeter of the frame to an upright position in which the projecting portion extends outward from the perimeter of the frame, the pedestal portion having a cam insert receivable in each of the first undercut and the second undercut, a clip insert receivable in each of the first undercut and the second undercut, the pedestal portion including a retention catch, the projecting portion having a body and a retention protrusion receivable in the retention catch for securing the projecting portion in the upright position,
the installation fin being reversibly couplable to the frame with the projecting portion extending toward the interior side in an interior direction in a first configuration of the prone position and with the projecting portion extending toward the exterior side in an exterior direction in a second configuration of the prone position.

2. The fenestration unit of claim 1, wherein the pedestal portion is configured to remain at least partially disposed in the receiver channel when the installation fin is moved relative to the frame from the prone position to the upright position.

3. The fenestration unit of claim 1, wherein the projecting portion having a first elastic modulus, the cam insert having a second elastic modulus, the second elastic modulus being less than the first elastic modulus.

4. The fenestration unit of claim 3, wherein the projecting portion is constructed of a first material having the first elastic modulus, the cam insert is constructed of a second material having the second elastic modulus, and the first material is different than the second material.

5. The fenestration unit of claim 1, wherein the pedestal portion further includes a stopper configured to be disposed outside of the receiver channel, each of the first lip and the second lip being receivable between the stopper and the clip insert.

6. The fenestration unit of claim 5, wherein the cam insert and the stopper each seal to the frame.

7. The fenestration unit of claim 5, wherein the projecting portion is constructed of a first material having the first elastic modulus, the stopper is constructed of a second material having the second elastic modulus, and the first material is different than the second material.

8. The fenestration unit of claim 1, wherein in the prone position the installation fin protrudes from the frame by a maximum distance in a range of about 0.100 inches to about 0.050 inches.

9. A fenestration unit having an interior side and an exterior side and being configured to be installed in a rough opening in a structure, the fenestration unit comprising:
a frame including a top, a bottom, a first side, and a second side together defining a perimeter of the frame, the frame having a receiver channel extending along the perimeter, the receiver channel being defined by a first lip, a second lip opposing the first lip, and a base over which the first lip and the second lip extend, the first lip and the second lip defining a gap between the first lip and the second lip, and a first undercut between the first lip and the base and a second undercut between the second lip and the base; and
an installation fin including a pedestal portion configured to be coupled to the frame, a projecting portion, and a hinge portion coupling the projecting portion to the coupling portion, the pedestal portion having a cam insert receivable in both of the first undercut and the second undercut, a clip insert receivable in both of the first undercut and the second undercut, and a retention catch, and the projecting portion having a body and a retention protrusion;
wherein the installation fin is reversibly couplable to the frame in a first configuration and a second configuration, in the first configuration the cam insert being received in the first undercut, the clip insert being received in the second undercut, the projecting portion being movable, via the hinge portion, relative to the frame from a first prone position to a first upright position, in the first prone position the projecting portion extending toward the interior side, and in the first upright position the projecting portion extending outwardly from the perimeter and the retention protrusion being received in the retention catch to secure the projecting portion, in the second configuration the cam insert being received in the second undercut, the clip insert being received in the first undercut, the projecting portion being movable, via the hinge portion, relative to the frame from a second prone position to a second upright position, and in the second prone position the projecting portion extending toward the exterior side, and in the second upright position the projecting portion extending outwardly from the perimeter and the retention protrusion being received in the retention catch to secure the projecting portion.

10. The fenestration unit of claim 9, wherein the projecting portion has a first elastic modulus, the cam insert has a second elastic modulus, the second elastic modulus being less than the first elastic modulus.

11. The fenestration unit of claim 10, wherein the projecting portion is constructed of a first material having the first elastic modulus, the cam insert is constructed of a second material having the second elastic modulus, and the first material is different than the second material.

12. The fenestration unit of claim 9, wherein the pedestal portion further includes a stopper configured to be disposed outside of the receiver channel, in the first configuration the second lip being received between the clip insert and the stopper, and in the second configuration the first lip being received between the clip insert and the stopper.

13. The fenestration unit of claim 12, wherein the cam insert and the stopper each seal to the frame.

14. The fenestration unit of claim 9, wherein the hinge portion flexes when the installation fin is moved relative to the pedestal portion from the first prone position to the first upright position and from the second prone position to the second upright position.

15. The fenestration unit of claim 9, wherein the projecting portion is disposed in a transverse plane in both the first upright position and the second upright position.

16. The fenestration unit of claim 9, wherein in the first prone position and the second prone position the installation fin protrudes from the frame by a maximum distance in a range of about 0.100 inches to about 0.050 inches.

17. A method of installing a fenestration unit in a rough opening in a structure defined by rough opening framing, the fenestration unit including an interior side, an exterior side, a frame having a top, a bottom, a first side, and a second side together defining a perimeter of the frame, the frame having a receiver channel extending along the perimeter, the receiver channel being defined by a first lip, a second lip opposing the first lip, and a base over which the first and second lips extend, the first and second lips defining a gap between the first and second lips, and a first undercut between the first lip and the base and a second undercut between the second lip and the base, and an installation fin including a pedestal portion, a projecting portion, and a flexible hinge between the pedestal portion and the projecting portion, the pedestal portion having a cam insert, a clip insert, and a retention catch, and the projecting portion having a body and a retention protrusion, the method comprising:
receiving the fenestration unit with the installation fin coupled to the frame in one of a first configuration and a second configuration, in the first configuration the cam insert being received in the first undercut, the clip insert being received in the second undercut, the projecting portion being movable, via the flexible hinge, relative to the frame from a first prone position to a first upright position, in the first prone position the projecting portion extending toward the interior side, and in the first upright position the projecting portion extending outwardly from the perimeter and the retention protrusion being received in the retention catch to secure the projecting portion, in the second configuration the cam insert being received in the second undercut, the clip insert being received in the first undercut, the projecting portion being movable, via the flexible hinge, relative to the frame from a second prone position to a second upright position, and in the second prone position the projecting portion extending toward the exterior side, and in the second upright position the projecting portion extending outwardly from the perimeter and the retention protrusion being received in the retention catch to secure the projecting portion;
detaching the installation fin from the frame;
coupling the installation fin to the frame in the other of the first configuration and the second configuration and positioning the installation fin in the first upright position or the second upright position, respectively;
seating the fenestration unit in the rough opening by together translating the frame and the installation fin toward the rough opening; and
securing the fenestration unit to the rough opening framing.

18. The method of claim 17, wherein coupling the installation fin to the frame comprises coupling the installation fin to the frame in the first configuration and positioning the installation fin in the first upright position.

19. The method of claim 17, wherein coupling the installation fin to the frame comprises coupling the installation fin to the frame in the second configuration and positioning the installation fin in the second upright position.

20. The method of claim 17, wherein detaching the installation fin from the frame includes removing the pedestal portion from the channel, and coupling the installation fin to the frame includes positioning the pedestal portion in the channel.

21. The method of claim 20, wherein the projecting portion has a first elastic modulus, the cam insert has a second elastic modulus, the second elastic modulus being less than the first elastic modulus.

22. The method of claim 20, wherein positioning the installation fin in the first upright position or the second upright position includes pivoting the projecting portion, via the flexible hinge, relative to the pedestal portion.

23. The method of claim 17, wherein securing the fenestration unit to the rough opening framing includes passing a plurality of fasteners through the installation fin and into the rough opening framing.

24. The method of claim 17, wherein in the first prone position and the second prone position the installation fin protrudes from the frame by a maximum distance in a range of about 0.100 inches to about 0.050 inches.

25. The method of claim 17, wherein detaching the installation fin from the frame includes moving the installation fin in a direction substantially perpendicular to a longitudinal axis of the receiver channel.

26. The method of claim 17, wherein coupling the installation fin to the frame in the other of the first configuration and the second configuration includes moving the installation fin in a direction substantially perpendicular to a longitudinal axis of the receiver channel.
